(19) United States
(12) Patent Application Publication
(10) Pub. No.: US 2004/0203464 A1
(43) Pub. Date: Oct. 14, 2004

(54) Analyzing a network problem in a wireless telecommunication system

(76) Inventor: Carol Katz, Longwood, FL (US)

Correspondence Address: CINGULAR WIRELESS, 5565 GLENRIDGE CONNECTOR, 9TH FLOOR MC 920, C/O LINDA GILES, SYSTEM ANALYST, ATLANTA, GA, 30342, US

(21) Appl. No.: 10/328,442

(22) Filed: Dec. 23, 2002

(51) Int. Cl. H04B 17/00

(52) U.S. Cl. 455/67.13; 455/67.11

(57) ABSTRACT

Analyzing a network problem in a wireless telecommunication system comprises a first system operator communicating substantially contemporaneously with a second system operator wherein trouble data is received from the second system operator, the trouble data comprising information identifying an anomaly on the wireless telecommunication system. In addition, analyzing a network problem in a wireless telecommunication system comprises collecting the trouble data in a trouble database and analyzing the trouble database to plan improvements to the wireless telecommunication system.

### DESCRIPTION OF THE INVENTION

1. Field of the Invention

The invention relates generally to systems and methods for analyzing a network problem in a wireless telecommunication system, and more particularly, to systems and methods for providing the geographic location of a network problem in a wireless telecommunication system.

2. Background of the Invention

The use of telephone products and systems in the day-to-day lives of most people is continually growing. With the advent and steady growth of wireless telecommunications, wireless telecommunication systems will increasingly be utilized for not only voice data, but also for sending and receiving packetized data for use on the Internet, for example. In an effort to lower operating costs and increase value for its subscribers, wireless telecommunication providers wish to analyze network problems in the wireless telecommunication system. Wireless telecommunication system providers may attract new subscribers to the wireless telecommunication system or may tend to retain current subscribers by analyzing and solving network problems. Thus, wireless telecommunication system providers may realize a competitive advantage by analyzing and solving network problems.

Therefore, the need to efficiently analyze a network problem in a wireless telecommunication system has become a common need for many wireless telecommunication providers. More specifically, providing the geographic location of a network problem in a wireless telecommunication system has become a critical service for many wireless telecommunication providers. This is because in an increasingly competitive environment, meeting and exceeding the expectations of subscribers or others who receive services is essential for a wireless telecommunication provider.

One solution to the network analysis problem, for example, is for an employee of the wireless telecommunication provider to simply call a voice mailbox and leave a message about the problem once detected. Great inefficiencies are created in this procedure because, for example, each home area within the wireless telecommunication system has its own voice mailbox. Moreover, to obtain the information in the voice mailbox, an engineer in the network operation center must laboriously obtain each message for each voice mailbox. Once the messages are obtained, many times the messages do not contain all the information necessary to define or solve the problem, may contain incorrect information, or may not be understandable. Accordingly, efficiently analyzing network problems in a wireless telecommunication system remains an elusive goal.

Thus, there remains a need to efficiently analyze a network problem in a wireless telecommunication system. In addition, there remains a need for providing the geographic location of a network problem in a wireless telecommunication system.

### SUMMARY OF THE INVENTION

Consistent with the present invention, methods and systems for analyzing a network problem in a wireless telecommunication system are provided that avoid problems associated with prior methods and systems for analyzing a network problem in a wireless telecommunication system as discussed herein above.

In one aspect, a method for analyzing a network problem in a wireless telecommunication system comprising a first system operator communicating substantially contemporaneously with a second system operator wherein trouble data is received from the second system operator, the trouble data comprising information identifying an anomaly on the wireless telecommunication system, collecting the trouble data in a trouble database, and analyzing the trouble database to plan improvements to the wireless telecommunication system.

In another aspect, a system for analyzing a network problem in a wireless telecommunication system comprises a component for communicating substantially contemporaneously between a first system operator and a second system operator wherein trouble data is received from the second system operator, the trouble data comprising information identifying an anomaly on the wireless telecommunication system, a component for collecting the trouble data in a trouble database, and a component for analyzing the trouble database to plan improvements to the wireless telecommunication system.

In yet another aspect, a computer-readable medium on which is stored a set of instructions for analyzing a network problem in a wireless telecommunication system, which when executed perform stages comprising a first system operator communicating substantially contemporaneously with a second system operator wherein trouble data is received from the second system operator, the trouble data comprising information identifying an anomaly on the wireless telecommunication system, collecting the trouble data in a trouble database, and analyzing the trouble database to plan improvements to the wireless telecommunication system.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 is a functional block diagram of an exemplary system for analyzing a network problem in a wireless telecommunication system consistent with an embodiment of the present invention;

FIG. 2 is a flow chart of an exemplary method for analyzing a network problem in a wireless telecommunication system consistent with an embodiment of the present invention;

FIG. 3 is a flow chart of an exemplary subroutine used in the exemplary method of FIG. 2 for communicating substantially contemporaneously between a first system operator and a second system operator consistent with an embodiment of the present invention; and

FIG. 4 is a flow chart of an exemplary subroutine used in the exemplary method of FIG. 2 for collecting the trouble data in a trouble database consistent with an embodiment of the present invention.

### DESCRIPTION OF THE EMBODIMENTS

Reference will now be made to various embodiments according to this invention, examples of which are shown in the accompanying drawings and will be obvious from the description of the invention. In the drawings, the same reference numbers represent the same or similar elements in the different drawings whenever possible.

Consistent with the general principles of the present invention, a system for analyzing a network problem in a wireless telecommunication system comprises a component for communicating substantially contemporaneously between a first system operator and a second system operator wherein trouble data is received from the second system operator, the trouble data comprising information identifying an anomaly on the wireless telecommunication system, a component for collecting the trouble data in a trouble database, and a component for analyzing the trouble database to plan improvements to the wireless telecommunication system.

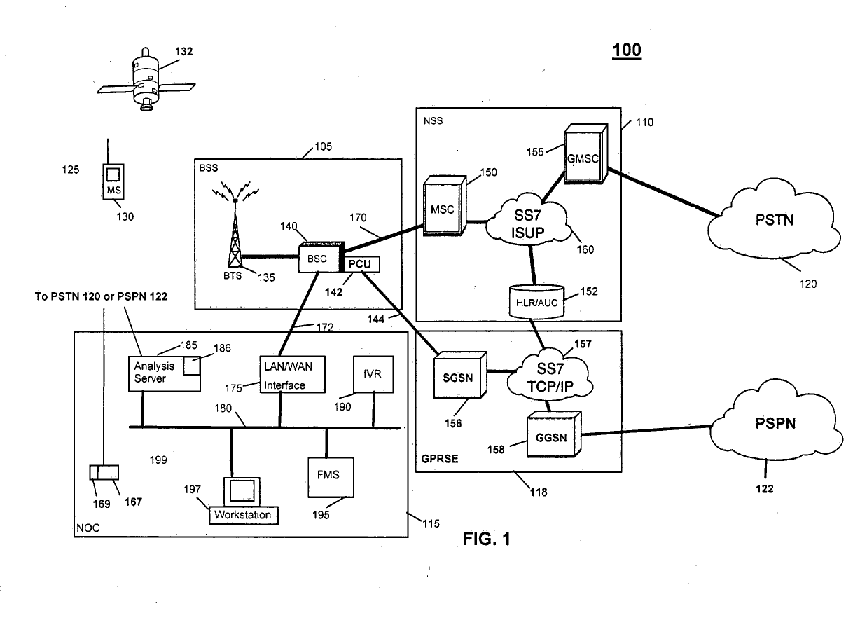

As herein embodied and illustrated in FIG. 1, a wireless telecommunication system 100 may comprise a base station subsystem (BSS) 105, a network and switching subsystem (NSS) 110, a network operation center (NOC) 115, a general packet radio service element (GPRSE) 118, a mobile station (MS) 130, a publicly switched telephone network (PSTN) 120, and a publicly switched packet network (PSPN) 122. The elements of system 100 will be described in detail below. Consistent with an embodiment of the invention, the secure server may comprise a secure server 185 (as described below). The first and second components may comprise secure server 185 in conjunction with PSTN 120 and a user device 121, or may comprise secure server 185 in conjunction with PSPN 122 and a user device 123. Those of ordinary skill in the art, however, will appreciate that other elements of system 100 may comprise the secure server, the first component, and the second component.

System 100 may utilize GSM technology enhanced with GPRS in embodiments of the present invention. Those of ordinary skill in the art will appreciate, however, that other wireless telecommunication technology standards may be employed, for example, FDMA, TDMA, CDMA, UMTS, EDGE and CDMA2000, without departing from the spirit of the invention.

Wireless telecommunications may include radio transmission via the airwaves, however, those of ordinary skill in the art will appreciate that various other telecommunication techniques can be used to provide wireless transmission including infrared line of sight, cellular, microwave, satellite, blue-tooth, packet radio, and spread spectrum radio. Wireless data may include, but is not limited to, paging, text messaging, e-mail, Internet access, instant messaging, and other specialized data applications specifically excluding or including voice transmission.

As shown in FIG. 1, BSS 105 may comprise, for example, a base transceiver station (BTS) 135, a base station controller (BSC) 140, and a packet control unit (PCU) 142. BSS 105 connects to MS 130 through a radio interface and connects to NSS 110 through an interface 170. BSC 140 controls BTS 135 and may control a plurality of other base transceiver stations in addition to BTS 135. BTS 135 may comprise radio transmission and reception equipment located at an antenna site. Associated with BSS 105, a transcoder/rate adaptation unit (TRAU) (not shown) may perform speech encoding and speech decoding and rate adaptation for transmitting data. As a subpart of BTS 135, the TRAU may be located away from BTS 135, for example, at a mobile switching center located in NSS 110. When the TRAU is located in this way, the low transmission rate of speech code channels allows more compressed transmission between BTS 135 and the TRAU.

PCU 142 connects BSS 105 to GPRSE 118, which allows, for example, the Internet to link with MS 130. PCU 142 adds level 2 functions of GPRS such as data aware radio link control (RLC) and the MAC protocol layer as well as performing radio resource configuration and channel assignment. Interface 170 between NSS 110 and BSS 105, and a wide area network 172 between BSC 140 and NOC 115, may comprise T-1 lines using X.25 or TCP/IP protocol, for example.

MS 130 may comprise a mobile phone, a personal computer, a hand-held computing device, a multiprocessor system, microprocessor-based or programmable consumer electronic device, a minicomputer, a mainframe computer, a personal digital assistant (PDA), a facsimile machine, a telephone, a pager, a portable computer, or any other device for receiving and/or transmitting information. MS 130 may utilize cellular telephone protocols such as wireless application protocol (WAP). Those of ordinary skill in the art will recognize that other systems and components may be utilized within the scope and spirit of the invention.

Furthermore, MS 130 may be configured to utilize the Global Positioning System (GPS). GPS is a system of 24 satellites for identifying earth locations created by the U.S. Department of Defense. By triangulation of signals from three of the satellites in the GPS, which may include satellite 132, a receiving unit, MS 130 for example, can pinpoint its current location anywhere on earth to within a small margin of error. By using GPS, MS 130 may periodically calculate its geographic location and send its geographic location periodically to server 185 or user device 167, either through NSS 110 and PSTN 120 or through GPRSE 118 and PSPN 122. Those of ordinary skill in the art will appreciate that there are many other way to send geographic location data from MS 130 to server 185, including, for example, a direct connection from BSS 105, NSS 110, or GPRSE 118 to server 185. In addition, those of ordinary skill in the art will appreciate that there are way other than using GPS to obtain geographic data.

Still referring to FIG. 1, NSS 110 may comprise a mobile switching center (MSC) 150, a home location register/authentication center (HLR/AUC) 152, a gateway mobile switching center (GMSC) 155, and a first network 160. NSS 1.10 manages the communication between subscribers, for example, a second system operator 125 using MS 130, and other telecommunications users, for example, a first system operator 199, using, for example, publicly switched telephone network (PSTN) 120. PSTN 120 may comprise, for example, the worldwide voice telephone network.

MSC 150 coordinates call set-up to and from subscribers such as operator 125 using MS 130. MSC 150 may control several base station controllers such as, and similar to BSC 140. GMSC 110 is used to interface with external networks for communication with users outside of the wireless system, such users on PSTN 120.

HLR/AUC 152 may comprise a stand-alone computer without switching capabilities, a database which contains subscriber information, and information related to the subscriber's current location, but not the actual location of the subscriber. The AUC portion of HLR/AUC 152 manages the security data for subscriber authentication. Another sub-division of HLR/AUC 152 may include an equipment identity register (EIR) (not shown) that may store data relating to mobile equipment (ME).

NSS 110 may also include a visitor location register (VLR) (not shown). The VLR links to one or more mobile switching center located on other systems, temporarily storing subscription data of subscribers currently served by MSC 150. The VLR holds more detailed data than HLR/AUC 152. For example, the VLR may hold more current subscriber location information than the location information at HLR/AUC 152.

GMSC 155 is utilized to interface with PSTN 120. In order to set up a requested call, the call is initially routed to GMSC 155, which finds the correct home location register by knowing the director number of the subscriber. GMSC 155 has an interface with an external network, such as PSTN 120, for gateway communications.

The elements of NSS 110 are connected using first network 160. First network 160: may comprise an intelligent network utilizing signal system 7 (SS7) in an ISDN user part (ISUP) protocol. ISUP is used for both ISDN and non-ISDN calls. Calls that originate and terminate at the same switch do not use ISUP signaling.

As shown in FIG. 1, GPRSE 118 may comprise a serving GPRS service node (SGSN) 156, a second network 157, and a gateway GPRS service node (GGSN) 158. In order to implement GPRS, two new node types may be added to a conventional GSM network, GGSN 158 and SGSN 156. Also, the interfaces to the conventional GSM system may be augmented and an extra unit, such as PCU 142 that may be located in BSS 105 as described above, may be added.

SGSN 156 connects GPRSE 118 to BSS 105 through interface 144, which may comprise T-1 lines using X.25 or TCP/IP protocol, for example. SGSN 156 receives the traffic from mobile subscribers associated with BSS 105 and forwards the traffic to GGSN 158. SGSN 156 uses its links with HLR/AUC 152 to authenticate and bill subscribers, and may provide additional services such as data compression, session management and encryption.

GGSN 158 acts as a gateway to PSPN 122, which is most often a publicly switched packet network such as the Internet. Data is sent across the GPRS network to GGSN 158, un-encapsulated, and then forwarded to the next node. To the outside world GGSN 158 may appear as just another router on the Internet. Common features of GGSN 158 may include firewall/packet-filtering technologies and a dynamic host configuration protocol (DHCP) server to configure IP options of MS 130 as it logs onto the network. DHCP automatically assigns IP addresses to client stations logging onto a TCP/IP network. It eliminates having to manually assign permanent IP addresses. DHCP software typically runs in servers and is found in network devices such as ISDN routers and modem routers that allow multiple users access to the Internet.

SGSN 156 and GGSN 158 are connected through second network 157. Second network 157 may employ SS7 as described above and use transmission control protocol/Internet protocol (TCP/IP).

Still referring to FIG. 1, network operation center (NOC) 115 may comprise a user device 167, a LAN/WAN interface 175, a local area network (LAN) 180, a server 185, an analysis database 186, an interactive voice response system (IVR) 190, a fault management system (FMS) 195, a workstation 197, and first system operator 199.

User device 167 may comprise a personal computer, a hand-held computing device, a multiprocessor system, microprocessor-based or programmable consumer electronic device, a minicomputer, a mainframe computer, a personal digital assistant (PDA), a facsimile machine, a telephone, a pager, a portable computer, or any other device for receiving and/or transmitting information as known by those of ordinary skill in the art. User device 167 may comprise a communication unit 169 capable of providing voice or data communications between communication unit 169 and MS 130. For example, communication unit 169 may include a radio, a cellular telephone, a wire line telephone, a hand-held computing device, microprocessor-based or programmable consumer electronic device, a personal digital assistant (PDA), a facsimile machine, a pager, or a portable computer. Those of ordinary skill in the art will appreciate that may other types of devices may comprise communication unit 169.

LAN/WAN interface 175 interfaces WAN 172 and LAN 180, thus connecting the elements connected to LAN 180 with BSC 140. Also connected to LAN 180 is server 185. Server 185 may comprise a personal computer, a hand-held computing device, a multiprocessor system, microprocessor-based or programmable consumer electronic device, a minicomputer, a mainframe computer, a personal digital assistant (PDA), a facsimile machine, a telephone, a pager, a portable computer, or any other device for receiving and/or transmitting information as known by those of ordinary skill in the art. Analysis database 186 may be located on storage media in server 185 or other storage media in systems, servers, or components accessible by server 185.

PSPN 122, most often a publicly switched packet network such as the Internet, may be accessed by first system operator 199 or second system operator 125 through user device 167 or MS 130 respectively in a conventional manner, as is known by those of ordinary skill in the art. Likewise, PSTN 120 is accessed by first system operator 199 or second system operator 125 through user device 167 or MS 130 respectively in a conventional manner as is known by those of ordinary skill in the art.

FMS 195 is a device used to detect, diagnose, and correct problems on system 100 effecting the security or reliability of system 100. Like server 185, FMS 195 may comprise a personal computer, a hand-held computing device, a multiprocessor system, microprocessor-based or programmable consumer electronic device, a minicomputer, a mainframe computer, a personal digital assistant (PDA), a facsimile machine, a telephone, a pager, a portable computer, or any other device for receiving and/or transmitting information. Workstation 197 allows first system operator 199 to interface with server 185, IVR 190, or FMS 195. Workstation 197 may comprise, for example, a scalable performance architecture (SPARC) station marketed by Sun Microsystems, Inc. of 901 San Antonio Road Palo Alto, Calif. 94303-4900. SPARC is a family of 32-bit RISC CPUs developed by Sun Microsystems, Inc.

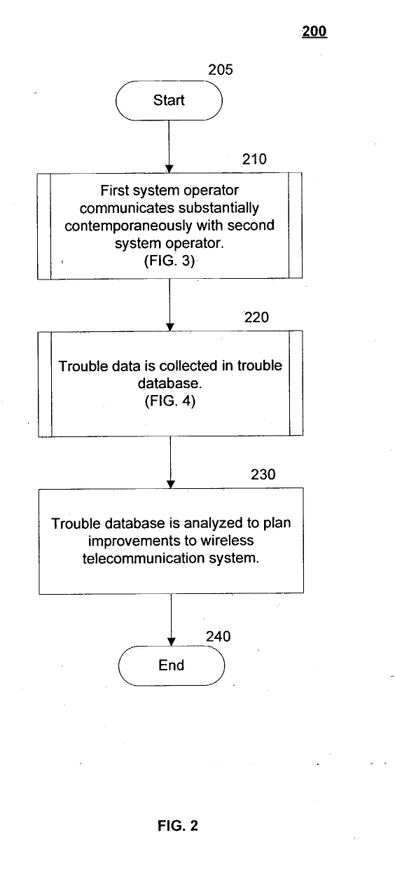

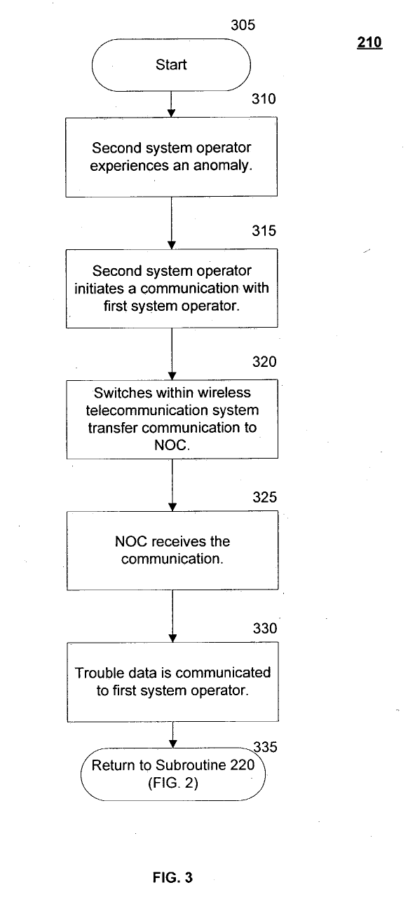

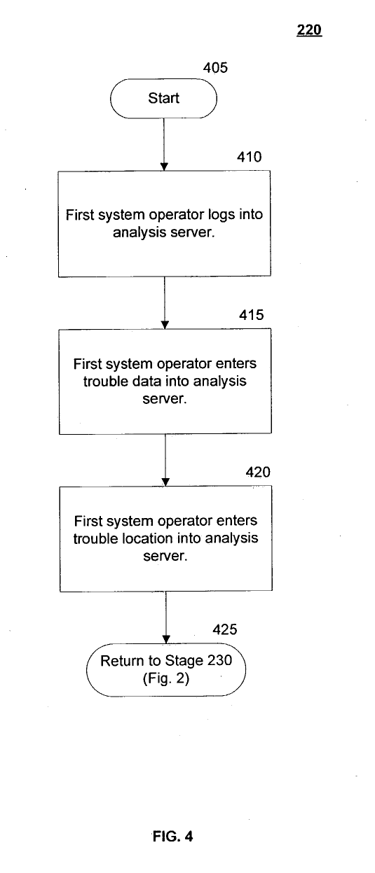

FIG. 2 is a flow chart setting forth the general stages involved in exemplary method for analyzing a network problem in a wireless telecommunication system consistent with an embodiment of the present invention. The implementation of the stages of exemplary method 200 in accordance with an exemplary embodiment of the present invention will be described in detail in FIG. 3 through FIG. 4. Exemplary method 200 begins at starting block 205 and proceeds to exemplary subroutine 210 where a first system operator communicates substantially contemporaneously with a second system operator wherein trouble data is received from the second system operator, the trouble data comprising information identifying an anomaly on the wireless telecommunication system. The stages of exemplary subroutine 210 are shown in FIG. 3 and will be described in detail below.

From exemplary subroutine 210 where a first system operator communicates substantially contemporaneously with a second system operator, exemplary method 200 continues to exemplary subroutine 220 where trouble data is collected in a trouble database. The stages of exemplary subroutine 220 are shown in FIG. 4 and will be described in detail below.

Once trouble data is collected in a trouble database in exemplary subroutine 220, exemplary method 200 advances to stage 230 where trouble database is analyzed to plan improvements to the wireless telecommunication system.

From stage 230 where trouble database is analyzed to plan improvements to the wireless telecommunication system, exemplary method 200 ends at stage 240.

FIG. 3 describes exemplary subroutine 210 from FIG. 2 for communicating substantially contemporaneously between a first system operator and a second system operator. Exemplary subroutine 210 begins at starting block 305 and advances to stage 310 where second system operator experiences an anomaly.

After second system operator experiences an anomaly in stage 310, exemplary subroutine 210 continues to stage 315 where second system operator initiates a communication with first system operator.

Once second system operator initiates a communication with first system operator in stage 315, exemplary subroutine 210 advances to stage 320 where switches within wireless telecommunication system transfer communication to NOC.

After switches within wireless telecommunication system transfer communication to NOC in stage 320, exemplary subroutine 210 continues to stage 325 where NOC receives the communication.

From stage 325 where NOC receives the communication, exemplary subroutine 210 advances to stage 330 where trouble data is communicated to first system operator. Once trouble data is communicated to first system operator in stage 330, exemplary subroutine 210 continues to stage 335 and returns to exemplary subroutine 220 of FIG. 2.

FIG. 4 describes exemplary subroutine 220 from FIG. 2 for collecting the trouble data in a trouble database. Exemplary subroutine 220 begins at starting block 405 and advances to stage 410 where first system operator logs into analysis server.

After first system operator logs into analysis server in stage 410, exemplary subroutine 220 continues to stage 415 where first system operator enters trouble data into analysis server.

Once first system operator enters trouble data into analysis server in stage 415, exemplary subroutine 220 advances to stage 420 where first system operator enters trouble location into analysis server.

From stage 420 where first system operator enters trouble location into analysis server, exemplary subroutine 220 continues to stage 425 and returns to stage 230 of FIG. 2.

It will be appreciated that a system in accordance with an embodiment of the invention can be constructed in whole or in part from special purpose hardware or a general-purpose computer system, or any combination thereof. Any portion of such a system may be controlled by a suitable program. Any program may in whole or in part comprise part of or be stored on the system in a conventional manner, or it may in whole or in part be provided in to the system over a network or other mechanism for transferring information in a conventional manner. In addition, it will be appreciated that the system may be operated and/or otherwise controlled by means of information provided by an operator using operator input elements (not shown) which may be connected directly to the system or which may transfer the information to the system over a network or other mechanism for transferring information in a conventional manner.

The foregoing description has been limited to a specific embodiment of this invention. It will be apparent, however, that various variations and modifications may be made to the invention, with the attainment of some or all of the advantages of the invention. It is the object of the appended claims to cover these and such other variations and modifications as come within the true spirit and scope of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for analyzing a network problem in a wireless telecommunication system, comprising:
a first system operator communicating substantially contemporaneously with a second system operator wherein trouble data is received from the second system operator, the trouble data comprising information identifying an anomaly on the wireless telecommunication system, wherein the trouble data comprises a geographic location of where the anomaly was discovered;
collecting the trouble data in a trouble database; and
analyzing the trouble database to plan improvements to the wireless telecommunication system.

2. The method of claim 1, wherein communicating substantially contemporaneously further comprises the second system operator contacting the first system operator, the second system operator using a mobile unit wherein the mobile unit in configured to receive an input, the input causing switches within at lest one of the wireless telecommunication system, a publicly switched telephone network, and a publicly switched packet network, to direct a call from the mobile unit to a communication unit in a network operation center (NOC), the communication unit operated by the second system operator.

3. The method of claim 1, wherein communicating substantially contemporaneously further comprises using at least one of a wireless telecommunication system, a publicly switched telephone network, and a publicly switched packet network.

4. The method of claim 1, wherein communicating substantially contemporaneously further comprises using at least one of telephone, cellular telephone, e-mail, facsimile, and Internet.

5. The method of claim 1, wherein communicating substantially contemporaneously further comprises using at least one voice data and packetized data.

6. The method of claim 1, wherein collecting the trouble data further comprises identifying the location of the network problem on a graphical user interface.

7. The method of claim 1, wherein analyzing the trouble database further comprises reviewing the data in the trouble database and identifying modifications in the wireless telecommunication system that would substantially eliminate the anomaly.

8. The method of claim 1, wherein the Global Positioning System (GPS) is used to determine the geographic location of where the anomaly was discovered.

9. The method of claim 1, wherein the second system operator comprises at least on of an employee, agent, and contractor for the operator of the wireless telecommunication system.

10. The method of claim 1, wherein the first system operator is trained in diagnosing the anomaly on the wireless telecommunication system.

11. A system for analyzing a network problem in a wireless telecommunication system, comprising:
a component for communicating substantially contemporaneously between a first system operator and a second system operator wherein trouble data is received from the second system operator, the trouble data comprising information identifying an anomaly on the wireless telecommunication system, wherein the trouble data comprises a geographic location of where the anomaly was discovered;
a component for collecting the trouble data in a trouble database; and
a component for analyzing the trouble database to plan improvements to the wireless telecommunication system.

12. The system of claim 11, wherein the component for communicating substantially contemporaneously further comprises the second system operator contacting the first system operator, the second system operator using a mobile unit wherein the mobile unit in configured to receive an input, the input causing switches within at lest one of the wireless telecommunication system, a publicly switched telephone network, and a publicly switched packet network, to direct a call from the mobile unit to a communication unit in a network operation center (NOC), the communication unit operated by the second system operator.

13. The system of claim 11, wherein the component for communicating substantially contemporaneously further comprises using at least one of a wireless telecommunication system, a publicly switched telephone network, and a publicly switched packet network.

14. The system of claim 14, wherein the component for communicating substantially contemporaneously further comprises using at least one of telephone, cellular telephone, e-mail, facsimile, and Internet.

15. The system of claim 11, wherein the component for communicating substantially contemporaneously further comprises using at least one voice data and packetized data.

16. The system of claim 11, wherein the component for collecting the trouble data further comprises identifying the location of the network problem on a graphical user interface.

17. The system of claim 11, wherein the component for analyzing the trouble database further comprises reviewing the data in the trouble database and identifying modifications in the wireless telecommunication system that would substantially eliminate the anomaly.

18. The system of claim 17, wherein the Global Positioning System (GPS) is used to determine the geographic location of where the anomaly was discovered.

19. The system of claim 11, wherein the second system operator comprises at least on of an employee, agent, and contractor for the operator of the wireless telecommunication system.

20. The system of claim 11, wherein the first system operator is trained in diagnosing the anomaly on the wireless telecommunication system.

21. A computer-readable medium on which is stored a set of instructions for analyzing a network problem in a wireless telecommunication system, which when executed perform stages comprising:
a first system operator communicating substantially contemporaneously with a second system operator wherein trouble data is received from the second system operator, the trouble data comprising information identifying an anomaly on the wireless telecommunication system, wherein the trouble data comprises a geographic location of where the anomaly was discovered;
collecting the trouble data in a trouble database; and
analyzing the trouble database to plan improvements to the wireless telecommunication system.

22. The computer-readable medium of claim 21, wherein communicating substantially contemporaneously further comprises the second system operator contacting the first system operator, the second system operator using a mobile unit wherein the mobile unit in configured to receive an input, the input causing switches within at lest one of the wireless telecommunication system, a publicly switched telephone network, and a publicly switched packet network, to direct a call from the mobile unit to a communication unit in a network operation center (NOC), the communication unit operated by the second system operator.

23. The computer-readable medium of claim 21, wherein communicating substantially contemporaneously further comprises using at least one of a wireless telecommunication system, a publicly switched telephone network, and a publicly switched packet network.

26. The computer-readable medium of claim 21, wherein communicating substantially contemporaneously further comprises using at least one of telephone, cellular telephone, e-mail, facsimile, and Internet.

27. The computer-readable medium of claim 21, wherein communicating substantially contemporaneously further comprises using at least one voice data and packetized data.

28. The computer-readable medium of claim 21, wherein collecting the trouble data further comprises identifying the location of the network problem on a graphical user interface.

29. The computer-readable medium of claim 21, wherein analyzing the trouble database further comprises reviewing the data in the trouble database and identifying modifications in the wireless telecommunication system that would substantially eliminate the anomaly.

30. The computer-readable medium of claim 21, wherein the Global Positioning System (GPS) is used to determine the geographic location of where the anomaly was discovered.

31. The computer-readable medium of claim 21, wherein the second system operator comprises at least on of an employee, agent, and contractor for the operator of the wireless telecommunication system.

32. The computer-readable medium of claim 21, wherein the first system operator is trained in diagnosing the anomaly on the wireless telecommunication system.
